(19) United States
(12) Patent Application Publication
(10) Pub. No.: US 2004/0049389 A1
(43) Pub. Date: Mar. 11, 2004

(54) Method and apparatus for streaming text to speech in a radio communication system

(76) Inventors: Paul Marko, Boca Raton, FL (US); Craig Wadin, Sunrise, FL (US)

Correspondence Address: Pablo Meles, Esq., Akerman, Senterfitt & Eidson, P.A., P.O. Box 3188, West Palm Beach, FL, 33402-3188, US

(21) Appl. No.: 10/238,555

(22) Filed: Sep. 10, 2002

(51) Int. Cl. G10L 13/08

(52) U.S. Cl. 704/260

(57) ABSTRACT

A radio system (10) deploying streaming text to speech channels includes a transmission source (11, 12, 14, 16 or 18) transmitting digitally encoded text on at least one of a plurality of digitally encoded channel resources (104) to a receiver unit (600) for selectively decoding the plurality of digitally encoded channel resources. The receiver unit includes a text to speech converter (612), which converts the digitally encoded text into an audible speech signal at the receiver unit in real time.

### CROSS-REFERENCE TO RELATED APPLICATIONS

(not applicable)

### FIELD OF THE INVENTION

The invention relates generally to a method and apparatus for speech transmission, and more particularly to a method and apparatus for delivering and receiving streaming audio via a text to speech conversion in a radio communication system.

### BACKGROUND OF THE INVENTION

Encoding speech for transmission in a radio communication channel with a typical speech codec requires substantial processing power for converting the speech into a compressed digital bit stream and the resulting bit stream demands substantial bandwidth for transmission. Implementing multiple speech channels using conventional speech codec technology in a communication system with limited bandwidth would severely limit the number of channels available. For example, trying to transmit 100 channels of speech would require an 800 kilobit per second channel using an 8 kilobit per second speech encoder. This would certainly seem like an expensive and inefficient use of bandwidth with respect to spectrum and the associated hardware required to implement such system. Thus, what is needed is an efficient method of providing speech services that is cost effective and bandwidth efficient in its application.

In a system discussed in U.S. Pat. Nos. 5,590,195 and 5,751,806 both by John O. Ryan and both assigned to Command Audio Corporation (and a related parent case, U.S. Pat. No. 5,406,626), alphanumeric data is transmitted on an FM sub-carrier and stored in memory for subsequent processing. It should be noted that the data sent in the Ryan patents is not “real-time” data or necessarily broadcast “live” in the usual sense and thus not processed as real-time data. (See Col. 7, lines 39-57 of '195). In other words, the Ryan patents do not teach the use of a live bit stream transmission intended for real time playback at a receiver.

Competitive broadcast services, such as satellite radio, demand efficient data transmission. Satellite radio operators provide digital quality radio broadcast services covering the entire continental United States. These services offer approximately 100 channels, of which 50 or more channels in a typical configuration will provide music with the remaining stations offering news, sports, talk and data channels.

Satellite radio improves over terrestrial radio's potential by offering a better audio quality, greater coverage and fewer commercials. Accordingly, in October of 1997, the Federal Communications Commission (FCC) granted two national satellite radio broadcast licenses. The FCC allocated 25 megahertz (MHZ) of the electromagnetic spectrum for satellite digital broadcasting, 12.5 MHz of which are owned by the assignee of the present application “XM Satellite Radio Inc.”

The system plan for XM Satellite Radio includes digital transmission of substantially the same program content from two or more geosynchronous or geostationary satellites to both mobile and fixed receivers on the ground. In urban canyons and other high population density areas with limited line-of-sight (LOS) satellite coverage, terrestrial repeaters rebroadcast the same program content in order to improve coverage reliability. Mobile receivers are capable of simultaneously receiving signals from two satellites and one terrestrial repeater for combined spatial, frequency and time diversity, which provides significant mitigation of multipath interference and addresses reception issues associated with blockage of the satellite signals. In accordance with XM Satellite Radio's unique scheme, the 12.5 MHZ band will be split into 6 slots. Four slots will be used for satellite transmission. The remaining two slots will be used for terrestrial reinforcement.

### SUMMARY OF THE INVENTION

In a first aspect of the present invention, a method for text to speech conversion in a radio communication system comprises the steps of receiving a text transmission over the air at a receiver and converting the text transmission to an audible speech signal at the receiver in real time.

In a second aspect of the present invention, a receiver capable of converting a received text transmission to audible speech comprises a decoder for decoding a received signal received over the air and containing the received text transmission and a text to speech converter for converting the received text transmission into an audible speech signal in real time. The receiver may also comprise an amplifier and speaker for playing the audible speech signal.

In a third aspect of the present invention, a radio system deploying streaming text to speech channels comprises a transmission source transmitting a plurality of digitally encoded channel resources, wherein the channel resources contains at least one channel resource containing digitally encoded text. The radio system further comprises a receiver for selectively decoding the plurality of digitally encoded channel resources, wherein the receiver further comprises a text to speech converter which converts the digitally encoded text into an audible speech signal at the receiver in real time.

In a fourth aspect of the present invention, a method of transmitting a digital audio radio broadcast transmission containing audio content, comprises the step of providing a plurality of digital music channels compressed with a first audio compression algorithm, the plurality of digital music channels containing data intended for text display on a receiving device and the step of providing at least one text channel transmitted at an average bit rate required for real-time playback by a text-to-speech converter in the receiving device, the at least one text channel containing associated data intended for text display on the receiving device.

In a fifth aspect of the present invention, a device for digital audio radio broadcast transmissions comprises a plurality of digital audio channels compressed with a first audio compression algorithm, wherein at least a first portion of plurality of digital audio channels contains associated data intended for text display on a receiving device and wherein at least a second portion of the plurality of digital audio channels contains associated data intended for real-time play back by a text-to-speech converter in the receiving device. The device further comprises a transmitter for transmitting the plurality of digital audio channels.

In a sixth aspect of the present invention, a device for receipt of digital audio radio broadcast transmissions comprises a receiver having a display and a speaker coupled thereto, wherein the receiver receives a plurality of digital audio channels compressed with a first audio compression algorithm, wherein at least a first portion of plurality of digital audio channels contains associated data intended for text display on the device. The device further comprises a text-to-speech converter in the receiver, wherein at least a second portion of the plurality of digital audio channels contains associated data intended for real-time play back by the receiver using the text-to-speech converter. At least one decoder is used for decoding the first portion of the plurality digital audio channels and for decoding the second portion of the plurality of digital audio channels.

### BRIEF DESCRIPTION OF THE DRAWINGS

FIG. 1 illustrates a satellite digital audio radio service system architecture in accordance with the present invention.

FIG. 2. is a diagram illustrating a representative bit stream in a frame format for distributing data in accordance with the present invention.

FIG. 3 is a diagram illustrating a communication resource providing text in accordance with the present invention.

FIG. 4 is a diagram illustrating the communication resource of FIG. 3 in further detail in accordance with the present invention.

FIG. 5. is a flowchart illustrating a method in accordance with the present invention.

FIG. 6 is a block diagram of a radio transmission source in accordance with the present invention.

FIG. 7 is a block diagram of a radio receiver unit in accordance with the present invention.

### DETAILED DESCRIPTION OF THE DRAWINGS

The present invention uses a broadcast radio service to deliver real-time streaming audio to listeners via text transmissions over-the-air. Correspondingly, a listener in accordance with the present invention preferably plays back the text transmission via a real-time text-to-speech converter at the receiver. Typical efficient applications of such text-to-speech radio channels are local traffic information, local weather information, stock or financial quotes, sports scores, transportation scheduling information, and real-time speech auxiliary information channels associated with music or talk channels as will be explained in further detail with respect to FIG. 4. Normal speech rates of 2.5 words per second and average word lengths of 10 characters at 8 bits per character would seem to indicate that 240 bit per second channels would be adequate for text-to-speech channels. Real-time compression algorithms, which compress the text prior to transmission and decompress the text at the receiver prior to text-to-speech conversion would further reduce the required channel bit rate. Without compression, a 24 kilobit per second channel could be subdivided to simultaneously support 100 channels providing real-time text to speech. This is readily achievable in a Satellite Digital Audio Radio Systems (SDARS) like the one provided by XM Satellite Radio.

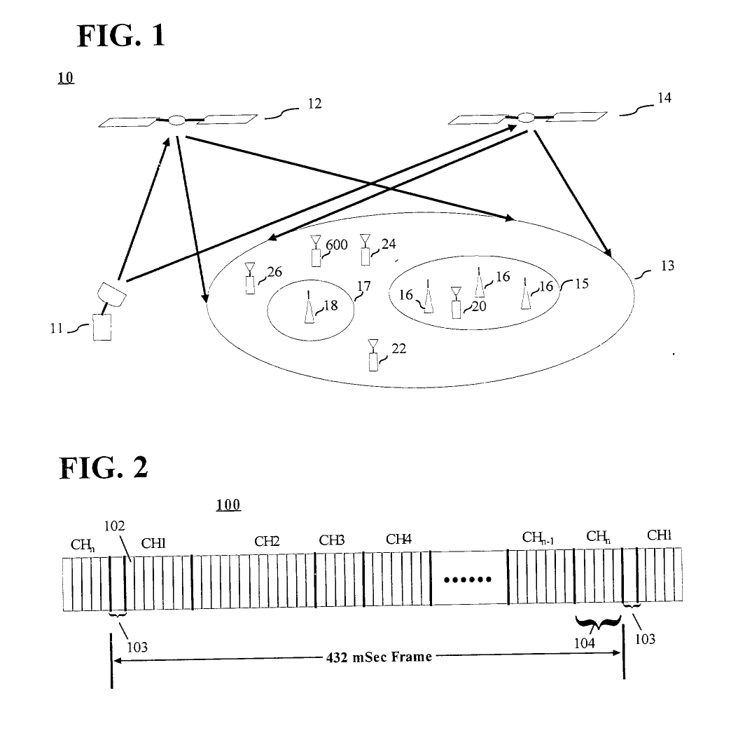

Referring to FIG. 1, satellite radio operators now provide digital radio service to the continental United States. Briefly, the service provided by XM Satellite Radio includes a satellite X-band uplink 11 to two satellites (12 and 14) which provide frequency translation to the S-band for re-transmission to radio receivers (20, 22, 24, and 26) on earth within the coverage area 13. The satellites provide for interleaving and spatial diversity. Radio frequency carriers from one of the satellites are also received by terrestrial repeaters (16 and 18). The content received at the repeaters are also “repeated” at a different S-band carrier to the same radios (20) that are within their respective coverage areas (15 and 17). These terrestrial repeaters facilitate reliable reception in geographic areas where LOS reception from the satellites is obscured by tall buildings, hills, tunnels and other obstructions. The signals transmitted by the satellites 12 and 14 and the repeaters are received by SDARS receivers 20-26. As depicted in FIG. 1, the receivers 20-26 may be located in automobiles, handheld or stationary units for home or office use. The SDARS receivers 20-26 are designed to receive one or both of the satellite signals and the signals from the terrestrial repeaters and combine or select one of the signals as the receiver output.

Referring to FIG. 2, a plurality of communication resource channels (Channel 1 through 100) are shown in accordance with the present invention. In this instance, the over-the-air protocol frame format 100 of the XM Satellite Radio system is shown. This frame format 100 is based on a 432 millisecond frame as shown in FIG. 2 where each frame is subdivided into 8 kilobit per second sub-channels 102. The first two 8 kilobit per second subchannels of each frame 103 are assigned to a Time Slot Control Channel (TSCC), which contains broadcast information about the remaining subchannels. This broadcast information includes service descriptive data to enable end users to view information pertinent to the services available, such as labels for active services, songs and artists and service categories and also includes format configuration data necessary for receivers to extract a specific service from the frame, such as service-to-sub-channel maps or similar data position indicators, as well as other broadcast data. The remaining subchannels 102 can be dynamically grouped to form higher bit rate payload channels 104. The payload channel or communication resource 104 provides the necessary bandwidth to transport a high-quality digital audio signal to the listener as well as other data as will become more apparent. When a listener changes channels, a receiver in accordance with the present invention simply extracts a different payload channel from the frame 100. It should be noted that each receiver in the XM Satellite System has a unique identifier allowing for the capability of individually addressing each receiver over-the-air to enable or disable services or to provide custom applications such as individual data services or group data services.

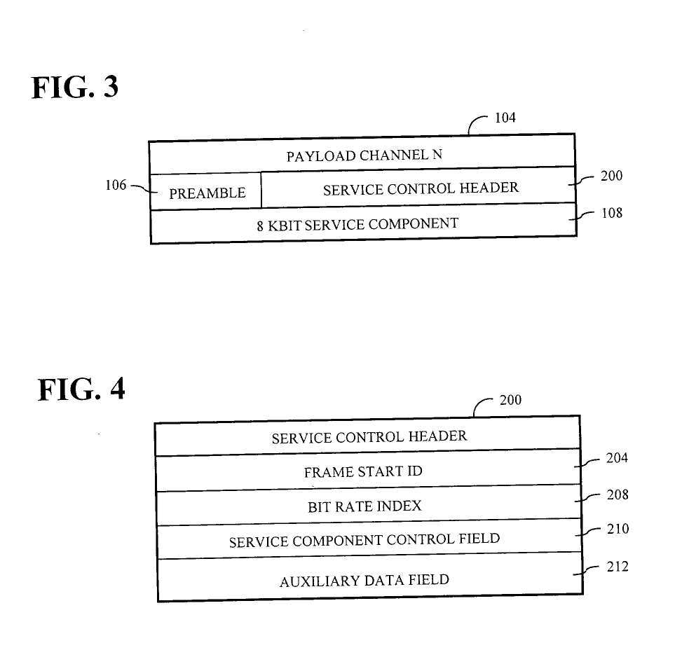

Referring to FIG. 3, each payload channel or communication resource 104 preferably comprises a preamble 106, a service control header 200 and a service component 108, which is 8 kilobits per second in this example. The service component contains the content that will be delivered to the listener, whether it is music, speech, text (which may or may not be converted to speech) or possibly video in future applications. Correspondingly with reference to FIG. 4, each service control header 200 comprises a frame start ID 204, bit rate index field 208, and a service component control field 210. The service component control field (SCCF) 210 would contain information about the service component 108. For example, a SCCF 210 might contain information indicating that the content in service component 108 is text and should be decoded using a text-to-speech converter. Alternatively, SCCF 210 might indicate that the content in service component is compressed digital audio and that an audio decoder is required.

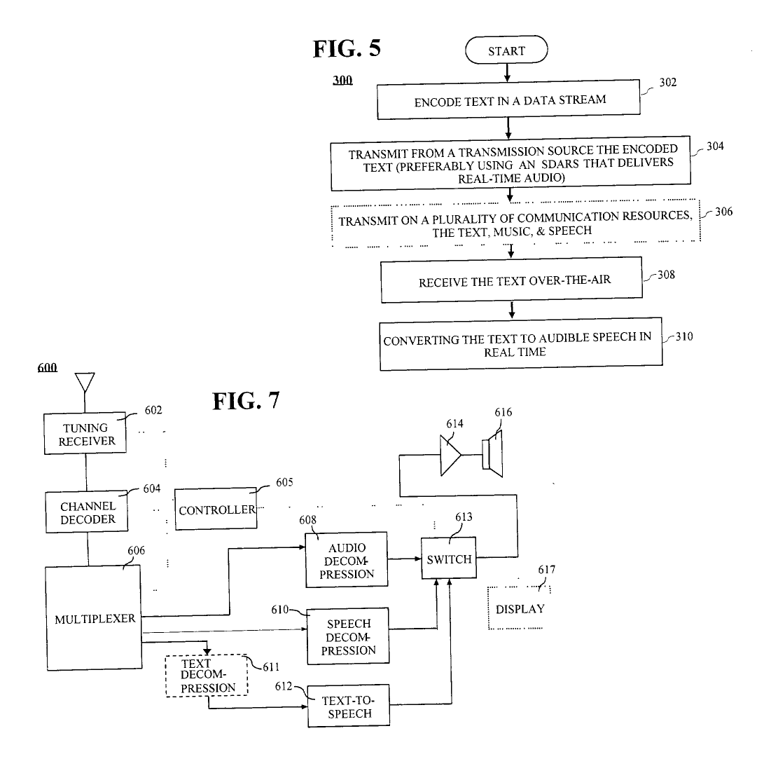

Referring to FIG. 5, a flow chart illustrating a text-to-speech method 300 in a communication system in accordance with the present invention is shown. At step 302, text is preferably encoded in a data stream as shown in FIG. 2. Preferably, the text is embedded in a portion of a payload channel or alternatively as part of the TSCC or an auxiliary data field 212 as shown in FIG. 4. At step 304, the encoded text is transmitted from a transmission source (preferably an SDARS system that delivers real-time streaming audio). Preferably, the transmission source provides a plurality of digital music channels compressed with a first audio compression algorithm, the plurality of digital music channels having associated data, transmitted simultaneous with the music channels and located in the TSCC or in the Payload Channel, intended for text display on a receiving device. The transmission source also provides at least one text channel transmitted at an average bit rate required for real-time (audio) playback by a text-to-speech converter in the receiving device, the at least one text channel also having associated service data intended for text display on the receiving device and having associated configuration data intended to enable the receiving device to extract the text channel from the frame. At step 306, the encoded text is transmitted over a plurality of communication resources or channels along with music and/or speech or other data. In other words, at least the text transmission on one of a plurality of communication resources, a digitally encoded music signal on another of the plurality, and optionally a digitally encoded speech signal on yet another of the plurality is transmitted. At step 308, the encoded text is received over the air at the receiving device. The plurality of resource channels containing the text transmission (and optionally the digitally encoded music signal or the digitally encoded speech signal) is preferably selectively decoded. The encoded text is then converted to an audible speech signal at the receiving device in real time at step 310.

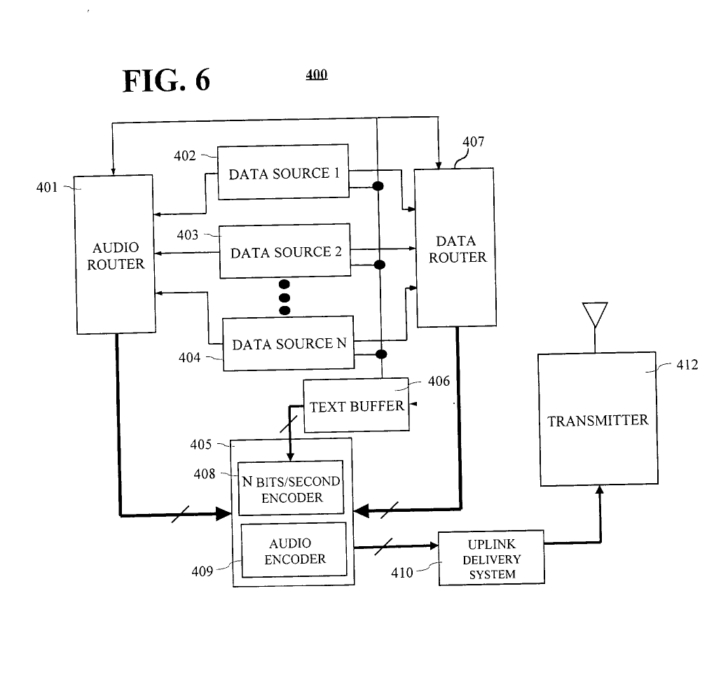

Referring to FIG. 6, a device 400 for digital audio radio broadcast transmissions is shown. The device 400 generates a plurality of real time digital audio channels, where each audio channel is comprised of either digital audio compressed with a first audio compression algorithm or streamed text intended for playback with a text-to-speech converter, wherein at least a first portion of plurality of real time digital audio channels contains associated data intended for text display on a receiving device and optionally at least a second portion of the plurality of digital audio channels contains associated data intended for real-time play back by a text-to-speech converter in the receiving device. In one particular embodiment as shown in FIG. 6, the plurality of digital audio channels are shown as “data source 1” 402, “data source 2” 403 and “data source N” 404. The data in the plurality of digital audio channels containing digital audio data will preferably be routed via an audio router 401 to an encoder 405. This data is encoded at a different rate than the data received by a text buffer 406 as will be further explained below. The data in the plurality of digital audio channels containing data associated with the audio data will preferably be routed via a data router 407 to the encoder 405. The data coming from the audio router 401 is preferably digital audio, which may be compressed with a first audio compression algorithm. The data routed via the data router 407 is preferably the first portion of the plurality of digital audio channels that contains associated data intended for text display on the receiving device. The data that is routed ultimately through the text buffer 406 is from digital audio channels configured for text-to-speech playback and optionally from the second portion of the plurality of digital audio channels that contains associated data and intended for real-time play back by a text-to-speech converter in the receiving device. The data routed through the text buffer 406 is preferably encoded at a rate of N bits/second that matches an N bits/second decoder used by the receiving device for live text-to-speech conversion. After encoding, the data is formatted, multiplexed and then routed via an uplink delivery system 410 to a transmitter 412 for transmitting the plurality of digital audio channels.

Referring to FIG. 7, a receiver unit 600 is shown capable of converting a received text transmission to audible speech. The receiver unit 600 preferably has a display 617 and a speaker 616 and the receiver unit further receives a plurality of digital audio channels comprised of either digital audio compressed with a first audio compression algorithm or streamed text encoded for real-time play back by a text-to-speech converter 612. The text-to-speech converter preferably has an N bit/second decoder matching the N bit/second encoder used by the transmitting device (see 408 of FIG. 6). At least a first portion of the plurality of digital audio channels contains associated data intended for text display on the receiver unit. Optionally, at least a second portion of the plurality of digital audio channels contains associated data intended for real-time play back by the receiver using a text-to-speech converter.

The receiver unit 600 preferably comprises a receiver 602 coupled to a decoder 604 for decoding a received signal received over the air and containing the received text transmission. The receiver 602 may also comprise tuning circuits (not shown) and the decoder 604 may also comprise decryption logic (if the data received is encrypted) as known in the art. The received signal containing the received text transmission is preferably received over the air and transmitted over a 240 bit per second channel. The receiver unit also preferably comprises a controller 605 and a multiplexer 606 for appropriately multiplexing signals between an audio decompressor 608, a speech decompressor 610, or the text-to-speech converter 612 for converting the received text transmission into an audible speech signal in real time. The resultant signal from either the audio decompressor 608, the speech decompressor 610, or the text-to-speech converter 612 is then amplified at amplifier 614 and outputted through speaker 616 for playing an audible speech signal. The audio decompressor 608 may also comprise digital to analog converters (not shown) as is known in the art. The resultant signal from the audio decompressor 608, the speech decompressor 610, or the textto-speech converter 612 may also contain associated data in the form of text that can optionally be displayed via the display 617. It should be understood that a receiver unit in accordance with the present invention could receive data in the form of text information that is associated with music, news, talk, or even the “text-to-speech” channels and essentially provides programming information such as channel id, artist name, song title, news segment title, talk show guest name, weather location, traffic location, and so on. This text data can optionally be displayed or remain embedded and invisible to the user of the receiver unit. It should also be understood that the text data received in a “text-to-speech” channel is likely to be separate and apart from the associated data that provides text information such as programming information for a given channel. The “text-to-speech” channel data would likely be encoded and decoded at a rate different from the data providing the music, news and talk channels or possibly even the text data associated with such channels. To further the efficiency of the text-to-speech channel, the real time text transmission may be compressed, allowing for reduced bit rates required for transmission. If the text is compressed, it would preferably be decompressed using a text decompressor 611 prior to application to the text-to-speech conversion in the receiver unit 602.

Thus, the present invention has been described herein with reference to a particular embodiment for a particular application. Those having ordinary skill in the art and access to the present teachings will recognize additional modifications, applications and embodiments within the scope thereof. For example, the present invention is not limited to use in satellite radio applications. It is therefore intended by the appended claims to cover any and all such applications, modifications and embodiments within the scope of the present invention. The description above is intended by way of example only and is not intended to limit the present invention in any way except as set forth in the following claims.

What is claimed is:

1. A method for text to speech conversion in a radio communication system, comprising the steps of:
receiving a text transmission over the air at a receiver; and
converting the text transmission to an audible speech signal at the receiver in real time.

2. The method of claim 1, wherein the text transmission is sent via the radio communication system using a digital audio radio system that delivers real-time streaming audio.

3. The method of claim 2, wherein the text transmission is embedded in a portion of a payload channel.

4. The method of claim 2, wherein the text transmission is embedded in a portion of an auxiliary data field.

5. The method of claim 1, wherein the method further comprises the step of receiving on a plurality of communication resource channels at least the text transmission on one of the plurality, a digitally encoded music signal on another of the plurality, and a digitally encoded speech signal on yet another of the plurality and further comprising the step of selectively decoding the communication resource channel containing the text transmission which contains text information about another communication resource channel containing the digitally encoded music signal or text information about another communication resource channel containing the digitally encoded speech signal.

6. The method of claim 1, wherein the text transmission is compressed text and the method further comprises the step of decompressing the text transmission.

7. A receiver capable of converting a received text transmission to audible speech, comprising:
a decoder for decoding a received signal received over the air and containing the received text transmission;
a text to speech converter for converting the received text transmission into an audible speech signal in real time; and
an amplifier and speaker for playing the audible speech signal.

8. The receiver of claim 7, wherein the receiver further comprises a separate decoder for decoding a portion of the received signal containing an audio signal.

9. The receiver of claim 7, wherein the received signal received over the air and containing the received text transmission is transmitted over a 240 bit per second channel.

10. The receiver of claim 7, wherein the received text transmission comprises compressed text and where the receiver further comprises a text decompressor used before the received text is converted to the audible speech signal.

11. A radio system deploying streaming text to speech channels, comprising:
a transmission source transmitting a plurality of digitally encoded channel resources, wherein the channel resources contains at least one channel resource containing digitally encoded text;
a receiver for selectively decoding the plurality of digitally encoded channel resources, wherein the receiver further comprises a text to speech converter which converts the digitally encoded text into an audible speech signal at the receiver in real time.

12. The radio system of claim 11, wherein the transmission source comprises a satellite uplink.

13. The radio system of claim 11, wherein the transmission source comprises a terrestrial repeater network.

14. The radio system of claim 11, wherein the transmission source comprises a satellite downlink.

15. The radio system of claim 11, wherein the plurality of digitally encoded channel resources comprises a portion of channel resources containing digitally encoded audio, a portion of channel resources containing digitally encoded speech, and the at least one channel resource containing digitally encoded text.

16. The radio system of claim 11, wherein the information content of the at least one channel resource containing digitally encoded text is selected from the group consisting of local weather information, local traffic information, financial information, sports scores, or transportation scheduling information.

17. The radio system of claim 11, wherein the receiver selectively decodes at least two of the plurality of digitally encoded channel resources including the at least one channel resource containing the digitally encoded text.

18. The radio system of claim 17, wherein the at least one channel resource containing the digitally encoded text provides descriptive information of another one of the plurality of digitally encoded channel resources.

19. The radio system of claim 17, wherein the at least one channel resource containing the digitally encoded text resides within a auxiliary data field of another one of the plurality of digitally encoded channel resources and provides information selected from the group consisting of artist name, song title, CD title, upcoming concerts, talk show host name, talk show host guest, talk show subject matter, or news show subject matter.

20. The radio system of claim 11, wherein the receiver further comprises a user input for selecting to play the digitally encoded text that provides information on a currently selected one of the plurality of digitally encoded channel resources containing music.

21. A method of transmitting a digital audio radio broadcast transmission containing audio content, comprising the steps of:
providing a plurality of digital music channels compressed with a first audio compression algorithm, the plurality of digital music channels containing data intended for text display on a receiving device; and
providing at least one text channel transmitted at an average bit rate required for real-time playback by a text-to-speech converter in the receiving device, the at least one text channel containing associated data intended for text display on the receiving device.

22. A device for digital audio radio broadcast transmissions, comprising:
a plurality of digital audio channels compressed with a first audio compression algorithm, wherein at least a first portion of plurality of digital audio channels contains associated data intended for text display on a receiving device and wherein at least a second portion of the plurality of digital audio channels contains associated data intended for real-time play back by a text-to-speech converter in the receiving device; and
a transmitter for transmitting the plurality of digital audio channels.

23. A device for receipt of digital audio radio broadcast transmissions, comprising:
a receiver having a display and a speaker coupled thereto, wherein the receiver receives a plurality of digital audio channels compressed with a first audio compression algorithm, wherein at least a first portion of plurality of digital audio channels contains associated data intended for text display on a the device;
a text-to-speech converter in the receiver, wherein at least a second portion of the plurality of digital audio channels contains associated data intended for real-time play back by the receiver using the text-to-speech converter;
at least one decoder for decoding the first portion of the plurality digital audio channels and for decoding the second portion of the plurality of digital audio channels.

24. The device of claim 23, wherein the associated data intended for text display from the first portion of the plurality of digital audio channels is different from the associated data within the second portion of the plurality of digital audio channels.

25. The device of claim 23, wherein the associated data intended for text display from the first portion of the plurality of digital audio channels is separately decoded from the associated data within the second portion of the plurality of digital audio channels.
